(19) United States
(12) Patent Application Publication
(10) Pub. No.: US 2003/0047692 A1
(43) Pub. Date: Mar. 13, 2003

(54) Measuring method and measuring apparatus, exposure method and exposure apparatus

(75) Inventors: Hiroyuki Nagasaka, Kumagaya-shi (JP); Takashi Aoki, Kumagaya-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/253,653

(22) Filed: Sep. 25, 2002

Related U.S. Application Data
(63) Continuation of application No. PCT/JP01/02633, filed on Mar. 29, 2001.

(30) Foreign Application Priority Data
Mar. 31, 2000 (JP) P2000-099650

(51) Int. Cl. G01N 31/22

(52) U.S. Cl. 250/492.22; 73/31.03; 216/59; 430/313; 430/396

(57) ABSTRACT

An object is to provide a measuring method and a measuring apparatus having excellent working efficiency, which can measure an optional substance contained in a predetermined gas accurately and promptly, and an exposure method and an exposure apparatus. An exposure apparatus S comprises; a measuring section M capable of measuring an absorptive substance, a gas supply unit N which can supply a gas GS in an optical path space LS to the measuring section M, a clean gas supply unit H which can supply a clean gas GT2 in which the absorptive substance has been reduced, to the measuring section M, and a switchover device B which can switch the supply of the gas GS and the clean gas GT2, to the measuring section M. Measurement of the concentration of the absorptive substance contained in the gas GS is performed accurately in a state where the residual absorptive substance in the measuring section M is reduced.

### TECHNICAL FIELD

The present invention relates to a measuring method and a measuring apparatus for measuring an optional substance contained in a predetermined gas, and an exposure method and an exposure apparatus.

This application is based on Japanese Laid-Open Patent Application No. Hei 12-99650, the contents of which are incorporated into this specification.

### BACKGROUND ART

In manufacturing of semiconductor devices, thin-film magnetic heads or liquid crystal display devices by a photolithography process, various kinds of exposure apparatus have heretofore been used. These exposure apparatus project an image of a pattern formed on a photo-mask or a reticle (hereinafter referred to as a “reticle”) onto a substrate, to which a photosensitizer such as a photo resist has been applied to the surface thereof. Recently, as the shape of the pattern projected onto a shot area on the substrate becomes finer, the exposure illumination light (hereinafter referred to as “exposure light”) to be used tends to have a shorter wavelength, and exposure apparatus using a KrF excimer laser (248 nm) or an ArF excimer laser (193 nm) are now been put to practical use, instead of a mercury lamp which has been the main stream heretofore. Exposure apparatus using an F2 laser (157 nm) are now under development, aiming at finer shapes of patterns.

When vacuum ultraviolet rays having a wavelength of about 180 nm or less are used as the exposure light, if a substance having a strong absorption property with respect to light in such a wavelength region (hereinafter referred to as “absorptive substance”), for example, oxygen molecules, water molecules, or carbon dioxide molecules, exists in the space in an optical path, which is a space through which the exposure light passes, this exposure light is dimmed out, and hence the exposure light cannot reach the substrate with sufficient strength. Therefore, in the exposure apparatus using vacuum ultraviolet rays, the concentration of the absorptive substance existing in the space in the optical path must be strictly controlled so as to suppress the concentration to as low as several ppms or below. In order to perform such a control, it is necessary to measure the concentration of the absorptive substance existing in the space in the optical path of the exposure light, by using a measuring apparatus. The concentration measurement of the absorptive substance should be performed promptly, in order to realize high throughput of the whole exposure apparatus.

Generally, in order to measure a substance to be measured (absorptive substance) of a several ppm level or less contained in the gas, it is necessary to reduce the substance to be measured remaining in piping or in a measuring section (sensor section) of the measuring apparatus to a predetermined value or below. This is because if the substance to be measured remains in the measuring apparatus, the measuring apparatus will show a value higher than the true value. However, it takes some time to reduce the residual substance to be measured to a predetermined value or below, so that the throughput of the whole operation is lowered. In this case, as the concentration of the residual substance becomes low, the operation for reducing the residual substance in the measuring apparatus requires a longer period of time, and hence it is difficult to obtain an accurate measurement result.

At the time of startup of the apparatus after shipment or at the time of maintenance, the optical path space is exposed to the air, so that absorptive substances such as oxygen exist in the optical path space. Therefore, in the exposure apparatus using vacuum ultraviolet rays, it is necessary to reduce the absorptive substances in the optical path space of the exposure light. Hence an operation is carried out for supplying an inert gas such as nitrogen gas or helium gas to the optical path space and exhausting the absorptive substance in the optical path space (purge), in order to fill the optical path space with an inert gas. In this purge process, it is effective to measure the oxygen concentration in the optical path space by a measuring apparatus capable of measuring oxygen concentration, in order to monitor the residual oxygen quantity in the optical path space. However, since the initial purge state is atmospheric air, oxygen remains in a large quantity in the measuring apparatus in the initial state of purge. As described above, in the state where oxygen remains in the measuring apparatus, the measured value becomes higher than the true value. Therefore, even if the optical path space is promptly purged with the inert gas and the true oxygen concentration becomes as low as several ppms or less, the measuring apparatus will show a measurement result indicating high concentration. Hence, completion of purge cannot be accurately confirmed. As a result, there are problems in that the concentration of the absorptive substance in the optical path space cannot be accurately measured, and the working efficiency of the whole exposure processing decreases, as well as causing a cost increase due to consumption of expensive purge gas.

In view of the above situation, it is an object of the present invention to provide a measuring method and a measuring apparatus having excellent working efficiency, which can measure an optional substance contained in a predetermined gas accurately and promptly, and an exposure method and an exposure apparatus.

### DISCLOSURE OF INVENTION

In order to solve the above problems, the present invention adopts the following constructions shown in the embodiments, corresponding to FIG. 1 to FIG. 8.

The measuring method of the present invention is a measuring method for measuring an optional substance contained in a predetermined gas, wherein before the predetermined gas is supplied to a measuring section capable of measuring the optional substance, a specific gas in which the concentration of the optional substance has been decreased is supplied to the measuring section, and after the specific gas has been supplied to the measuring section, the predetermined gas is supplied to the measuring section, to thereby measure the optional substance. In this measuring method, supply of the predetermined gas and supply of the specific gas may be carried out alternately.

According to the present invention, when the optional substance contained in the predetermined gas is measured by the measuring section, the specific gas in which the concentration of the optional substance has been reduced is supplied to the measuring section before supplying the predetermined gas. As a result, the optional substance remaining in the measuring section can be reduced. By supplying the predetermined gas to the measuring section in the state where the optional substance is reduced, the optional substance can be accurately measured. At this time, by alternately supplying the predetermined gas and the specific gas, measurement can be performed efficiently within a short period of time, even in a region where the optional substance is contained in the predetermined gas in a small amount.

This measuring method is for measuring the concentration of the optional substance in the predetermined gas, and even if the optional substance is in a low concentration region (several ppm), accurate concentration measurement can be performed in all concentration regions by alternately supplying the predetermined gas and the specific gas. Moreover, even when the concentration of the optional substance in the predetermined gas changes, the concentration at the time of measurement can be accurately monitored.

At this time, the specific gas is supplied to the measuring section and at a point in time when the measurement of concentration of the optional substance becomes lower than a predetermined value, the predetermined gas is then supplied. As a result, the concentration measurement corresponding to the desired measurement accuracy can be efficiently carried out. That is to say, for example, when it is desired to measure a concentration of 10 ppm, the specific gas may be supplied to the measuring section, and for example, when the measurement shows 10 ppm or less, supply of the specific gas is stopped, and the predetermined gas is supplied. In this manner, supply of the specific gas may be carried out depending on the target measurement accuracy. As a result, excessive supply of the specific gas can be avoided, thereby enabling efficient measurement.

This measuring method can be executed by a measuring apparatus for measuring an optional substance contained in a predetermined gas, which comprises; a measuring section capable of measuring the optional substance, a predetermined gas supply unit capable of supplying the predetermined gas to the measuring section, a specific gas supply unit capable of supplying a specific gas in which the concentration of the optional substance is reduced, to the measuring section, and a switchover device which can switch the gas supply to the measuring section, between from the predetermined gas supply unit and from the specific gas supply unit, so that after the specific gas has been fed to the measuring section, the predetermined gas is fed thereto. This measuring apparatus may have a control unit which is connected to the switchover device for executing switchover of the gas supply several times. The predetermined gas and the specific gas may be the same kind of gas.

This measuring apparatus is for measuring the concentration of the optional substance in the predetermined gas. The control unit executes supply of the specific gas to the measuring section, and at a point in time when a measurement of the concentration becomes less than a predetermined value, operates the switchover device.

The objects to be measured by the measuring method and the measuring apparatus of the present invention include oxygen molecules, water molecules and carbide, as well as substances such as ammonia compounds, Si based compounds (silane base compounds), halogenated compounds, NOx and SOx, and mixtures thereof.

The exposure method of the present invention is an exposure method in which an exposure light is irradiated onto a mask, and an image of a pattern formed on the mask is transferred to a substrate, wherein after supplying to a measuring section capable of measuring an absorptive substance which absorbs the exposure light in a space containing an optical path of the exposure light, a specific gas in which the absorptive substance has been reduced, the absorptive substance in the space is measured by the measuring section, and the transfer processing is carried out according to the measurement result.

According to the present invention, the absorptive substance in the space is measured by the measuring section, after the specific gas in which the absorptive substance is reduced has been supplied to the measuring section capable of measuring the absorptive substance. Therefore, the absorptive substance in the space can be measured accurately and promptly, in the state with the absorptive substance remaining in the measuring section being reduced. As a result, the condition in the optical path space, such as for example, whether the optical path space is in a normal state capable of performing transfer processing, can be determined accurately and promptly, thereby enabling stable exposure processing with excellent working efficiency.

This exposure method can be executed by an exposure apparatus which irradiates an exposure light onto a mask, and transfers an image of a pattern formed on the mask to a substrate, wherein the exposure apparatus comprises; a measuring section capable of measuring an absorptive substance which absorbs the exposure light in a space containing an optical path of the exposure light, a gas supply unit which can supply a gas in the space, to the measuring section, a specific gas supply unit which can supply a specific gas in which the absorptive substance has been reduced, to the measuring section, a switchover device which can switch the gas supply to the measuring section, between from the gas supply unit and from the specific gas supply unit, and a control unit which instructs the switchover device to supply the specific gas from the specific gas supply unit for a predetermined period of time, and thereafter supply the gas from the gas supply unit.

The exposure method of the present invention is an exposure method in which an exposure light is irradiated onto a mask, and an image of a pattern formed on the mask is transferred to a substrate, wherein after a specific gas in which an absorptive substance is reduced has been supplied to a measuring section capable of measuring an absorptive substance which absorbs the exposure light in a space containing an optical path of the exposure light, the absorptive substance in the space is measured by the measuring section, the gas in the space and the specific gas in which the absorptive substance is reduced are alternately supplied, the absorptive substance is measured, and transfer processing is carried out according to the measurement result. Moreover, the transfer processing may be carried out after the concentration of the absorptive substance in the space becomes less than a predetermined value. Furthermore, the space containing the optical path of the exposure light may be divided into a plurality of spaces, and the measuring section selectively connected to the plurality of spaces. In addition, the concentration of the absorptive substance exhausted from the space may be monitored, and the space and the measuring section connected when the concentration of the absorptive substance is less than a predetermined value.

According to the present invention, by supplying the specific gas in which the absorptive substance is reduced, to the measuring section capable of measuring the absorptive substance, the absorptive substance remaining in the measuring section can be reduced. Since the absorptive substance in the space is measured by the measuring section in the state with the absorptive substance reduced, the absorptive substance in the space can be accurately measured. At this time, even in a region where the absorptive substance in the space is in a small amount, measurement can be performed efficiently within a short period of time, by alternately carrying out supply of the gas in the space and supply of the specific gas, to the measuring section. Moreover, even when the amount of absorptive substance in the space changes, the absorptive substance at the time of measurement can be accurately monitored.

This exposure method can be executed by an exposure apparatus which irradiates an exposure light onto a mask, and transfers an image of a pattern formed on the mask to a substrate, wherein the exposure apparatus comprises; a measuring section capable of measuring an absorptive substance which absorbs the exposure light in a space containing an optical path of the exposure light, a gas supply unit which can supply a gas in the space, to the measuring section, a specific gas supply unit which can supply a specific gas in which the absorptive substance is reduced, to the measuring section, a switchover device which can switch the gas supply to the measuring section, between from the gas supply unit and from the specific gas supply unit, and a control unit which controls the switchover device such that after the specific gas has been supplied to the measuring section from the specific gas supply unit, the gas is supplied from the gas supply unit.

The control unit may control the switchover device such that supply of the gas in the space and supply of the specific gas are alternately carried out. Furthermore, the space containing the optical path of the exposure light may be divided into a plurality of spaces containing an illumination system housing for housing an illumination optical system which irradiates the exposure light to the mask, a mask chamber for housing a mask stage which holds the mask, a projection system housing for housing a projection optical system which transfers an image of the pattern formed on the mask to the substrate, and a substrate chamber for housing a substrate stage which holds the substrate. The exposure apparatus may comprise a connection device which selectively connects the measuring section with the plurality of spaces. In addition, the exposure apparatus may have a second measuring apparatus for monitoring the concentration of the absorptive substance exhausted from the space, and the control unit may connect the space and the measuring section, based on the monitoring result by the second measuring apparatus.

### BRIEF DESCRIPTION OF DRAWINGS

FIG. 1 is a block diagram for explaining a first embodiment of an exposure apparatus having a measuring apparatus of the present invention.

FIG. 2 is a block diagram for explaining the measuring apparatus and a gas replacement apparatus.

FIG. 3 is a diagram for explaining a measuring method of the present invention.

FIG. 4 is a block diagram for explaining another embodiment of the exposure apparatus having the measuring apparatus of the present invention.

FIG. 5 is a block diagram for explaining a second embodiment of the exposure apparatus having the measuring apparatus of the present invention.

FIG. 6 is a block diagram for explaining a third embodiment of the measuring apparatus of the present invention.

FIG. 7 is a block diagram for explaining a fourth embodiment of the measuring apparatus of the present invention.

FIG. 8 is a flowchart showing one example of a manufacturing process for semiconductor devices.

### BEST MODE FOR CARRYING OUT THE INVENTION

First Embodiment:

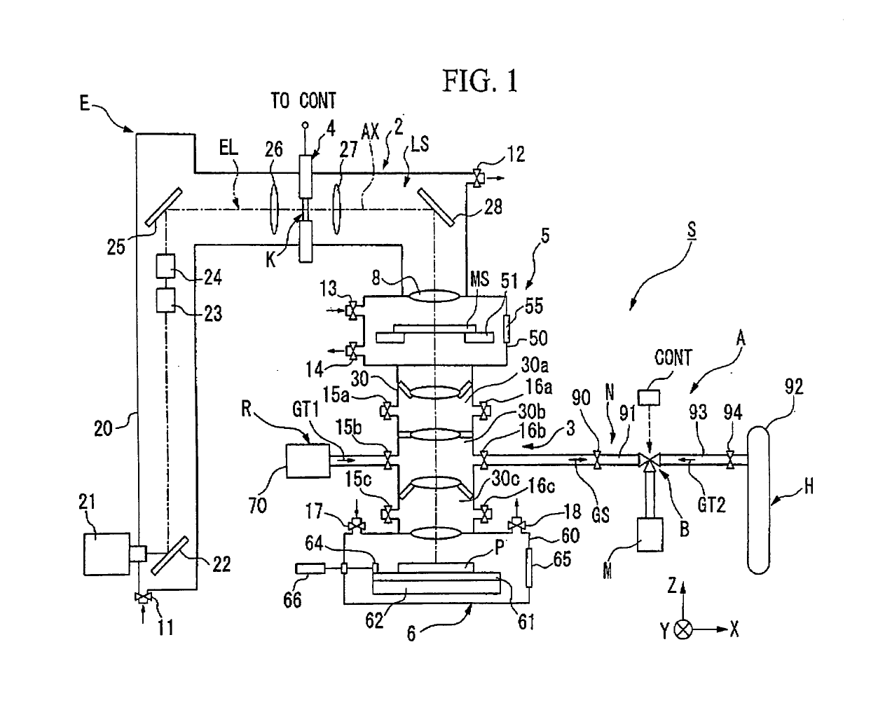

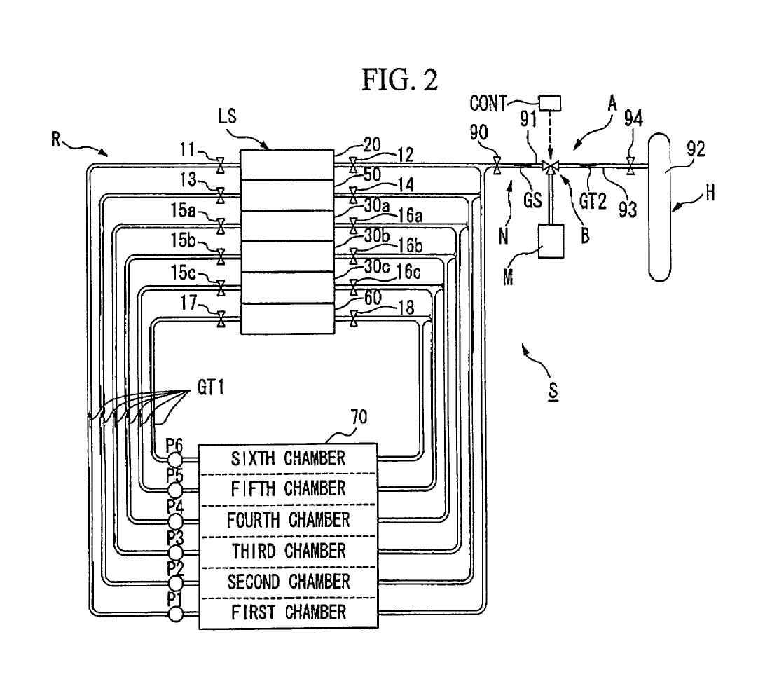

The measuring method and the measuring apparatus, and the exposure method and the exposure apparatus according to one embodiment of the present invention will be described, with reference to the drawings. FIG. 1 is a block diagram showing a first embodiment of an exposure apparatus having a measuring apparatus of the present invention, and FIG. 2 is a block diagram for explaining the measuring apparatus and a gas replacement apparatus.

In FIG. 1 and FIG. 2, the exposure apparatus S comprises; an exposure apparatus body E which irradiates exposure light EL onto a mask MS and transfers an image of a pattern formed on the mask MS to a substrate P, and a gas replacement apparatus (absorptive substance reduction apparatus) R which reduces the absorptive substance in the optical path space LS. Moreover, the exposure apparatus S comprises a measuring apparatus A. This measuring apparatus A comprises; a measuring section M capable of measuring an absorptive substance existing in the optical path space LS, a predetermined gas supply unit (gas supply unit) N capable of supplying the gas GS in the optical path space LS to the measuring section M, a specific gas supply unit (clean gas supply unit) H capable of supplying a specific gas (clean gas) GT2 to the measuring section M, and a switchover device B which can switch the gas supply to the measuring section M, between from the predetermined gas supply unit N and from the clean gas supply unit H. The operation of the whole exposure apparatus S, as represented by the switchover device B, is controlled by the control unit CONT.

Here “absorptive substance” is a substance having a strong absorptive property with respect to light (exposure light EL) having a wavelength in the vacuum ultraviolet region, and includes, for example, gases of oxygen, water vapor and hydrocarbon. On the other hand, “specific gas” is a gas in which a substance to be measured by the measuring section M is sufficiently reduced, and includes, for example, inert gases such as nitrogen, helium, argon, neon and krypton, which have a less absorptive property with respect to light having a wavelength in the vacuum ultraviolet region, or mixture gases thereof. Hereinafter, the specific gas is appropriately referred to as a “low absorptive substance” or an “inert gas”.

As shown in FIG 1, the exposure apparatus body E comprises; an illumination optical system 2 which irradiates beams of light from a light source 21 onto the mask MS, a blind section 4 arranged in the illumination optical system 2 for adjusting the area of an opening K for allowing the exposure light EL to pass through, to thereby restrict the illumination range on the mask MS by the exposure light EL, a mask chamber 5 for housing the mask MS, a projection optical system 3 for projecting an image of the pattern on the mask MS illuminated by the exposure light EL onto the substrate P, and a substrate chamber 6 for housing the substrate P.

The light source 21 is for emitting vacuum ultraviolet rays having a wavelength of from about 120 nm to about 180 nm into the illumination optical system 2, and is constituted of, for example, a fluorine laser (F2 laser) having an emission wavelength of 157 nm, a krypton dimer laser (Kr2 laser) having an emission wavelength of 146 nm, or an argon dimer laser having an emission wavelength of 126 nm. An ArF laser excimer laser or the like having an emission wavelength of 193 nm may be used for the light source 21.

The illumination optical system 2 comprises; an optical integrator 24, such as a fly-eye lens or a rod lens, which adjusts the beams of light emitted from the light source 21, which have been reflected by a reflection mirror 22 and have passed through a relay lens 23, to beams of light having a substantially uniform illuminance distribution, to thereby convert the beams of light into the exposure light EL, a mirror 25 which guides the exposure light EL to the blind section 4 via a lens system 26, and a reflection mirror 28 which guides the exposure light EL having passed through a lens system 27, whose illumination range is regulated by the blind section 4, to the mask MS. Each of the optical members and the blind section 4 are arranged inside of the illumination system housing 20, being a sealed space, at a predetermined position. In this case, the blind section 4 is arranged on a conjugate plane with a pattern plane of the mask MS.

By adjusting the size of the opening K of the blind section 4, then of the exposure light EL shone from the optical integrator 24 only the exposure light EL having passed therethrough is sent to the lens system 27. The exposure light EL regulated by the opening K illuminates a specific area on the mask MS arranged in the mask chamber 5. via the lens system 27 at a substantially uniform illuminance.

The mask chamber 5 comprises a mask holder 51 (mask stage) for holding the mask MS by vacuum attraction. This mask chamber 5 is covered with a partition 50, which is joined with the illumination system housing 20 and the projection system housing 30 of the projection optical system 3 without any gap therebetween. An opening for carrying in or out the mask MS is provided on the sidewall of the partition 50, and an opening/closing door 55 is provided in this opening. By closing the opening/closing door 55, the mask chamber 5 is sealed up. The mask holder 51 has an opening corresponding to the pattern area, which is an area where the pattern on the mask MS is formed, and is able to be slightly moved in the X direction, the Y direction and the θ direction (rotation direction about the Z axis) by a drive mechanism (not shown). As a result, positioning of the mask MS is possible so that the center of the pattern area passes through the optical axis AX of the projection optical system 3. The drive mechanism for the mask holder 51 is constituted by using, for example, two pairs of voice coil motors. A transmission window 8 is arranged at the ceiling of the partition 50 of the mask chamber 5, so as to separate the internal space of the illumination system housing 20 from the internal space of the mask chamber 5 where the mask MS is arranged.

The projection optical system 3 is for imaging an image of a pattern existing in the illumination range regulated by the opening K for the exposure light EL of the mask MS, onto the substrate P to thereby expose the pattern image in a specific area (shot area) on the substrate P. This projection optical system 3 is obtained by scaling a plurality of optical members such as lenses consisting of a fluorite or a fluoride crystal such as lithium fluoride, and reflection mirrors, by means of the projection system housing 30. In this embodiment, three sealed spaces 30a, 30b and 30c, which are separated by each optical member, are formed in the projection system housing 30. The projection optical system 3 is formed of a reduction optical system having a projection magnification of for example ¼ or ⅕. Therefore, the pattern formed on the mask MS is projected in a reduced size onto the shot area on the substrate P by the projection optical system 3, and a reduced image of the pattern is transferred and formed on the substrate P.

The substrate chamber 6 comprises a substrate holder 61 for holding the substrate P by vacuum attraction. This substrate chamber 6 is covered with a partition 60, which is joined with the projection system housing 30 without any gap therebetween. An opening for carrying in or out the substrate P is provided in the sidewall of the partition 60, and an opening/closing door 65 is provided in this opening. By closing the opening/closing door 65, the substrate chamber 6 is sealed up. The substrate holder 61 is supported on a substrate stage 62. The substrate stage 62 is formed by overlapping a pair of blocks movable in directions orthogonal to each other, so as to be movable in the horizontal direction along the X-Y plane. Alternatively, the substrate stage 62 is freely driven in the X-Y plane along the upper face of the base and without contact, by means of a wafer drive system (not shown) comprising, for example, a magnetic floating type two-dimensional linear motor (plane motor) or the like. That is to say, the substrate P fixed to this substrate stage 62 is movably supported in the horizontal direction along the X-Y plane (in a perpendicular direction to the optical axis AX of the projection optical system 3).

The position of the substrate stage 62 is detected based on the light of a laser beam from a laser interferometer 66, which is reflected from a movable mirror 64 on the substrate stage 62. The detection value is transmitted to the control unit CONT, and the control unit CONT controls the position of the substrate stage 62, while monitoring the detection value of the laser interferometer, at the time of stepping between respective shot areas.

Internal spaces (sealed spaces) respectively formed in the illumination system housing 20 of the illumination optical system 2, the mask chamber 5, the projection system housing 30 in the projection optical system 3 and the substrate chamber 6, become the optical path space LS of the exposure light EL emitted from the light source 21 and irradiated onto the substrate P, for which the incoming and outgoing of the gas from and to the outside is blocked.

In the exposure apparatus body E (exposure apparatus S) of this embodiment, the stepping operation between shots, in which the substrate stage 62 is moved so as to sequentially position each shot area on the substrate P to the exposure position, and the exposure operation, in which the exposure light EL is illuminated onto the mask MS in the positioned state, to transfer an image of the pattern formed on the mask MS to the shot area on the substrate P, are repetitively carried out by the control unit CONT.

The gas replacement apparatus R will be described, with reference to FIG. 1 and FIG. 2. The gas replacement apparatus R is for reducing the concentration of the absorptive substance existing in the optical path space LS, consisting of the illumination system housing 20, the mask chamber 5, the projection system housing 30 and the substrate chamber 6. The gas replacement apparatus R exhausts gas GS in the optical path space LS, as well as supplying an inert gas GT1 to the optical path space LS, to thereby reduce the concentration of the absorptive substance.

The gas GS in the optical path space LS is atmospheric air (air) at the time of startup of the apparatus after shipment or at the time of maintenance, and is an inert gas after the startup of the apparatus and after completion of maintenance. However, even if the optical path space LS is filled with the inert gas, there is the possibility that absorptive substances may be contained in the inert gas, due to the out-gas generated from hardware articles around the optical path space and wiring. Therefore, the gas GS in the optical path space LS after the startup of the apparatus and after completion of maintenance corresponds to inert gas containing absorptive substances.

As shown in FIG. 2, the gas replacement apparatus R comprises a specific gas storage section (purge gas storage section) 70 which stores a low absorptive substance (specific gas) GT1, and is connected to the optical path space LS by an air supply duct and an exhaust duct. This specific gas storage section 70 has six chambers, namely a first chamber to a sixth chamber, filled with the same kind of low absorptive substance (specific gas) GT1, and corresponding to each space of the illumination system housing 20, namely the mask chamber 5, each space, 30a, 30b and 30c in the projection system housing 30 and the substrate chamber 6. Each chamber of the specific gas storage section 70 and each space in the optical path space LS are respectively connected by the air supply duct which supplies the specific gas (purge gas) GT1 from each chamber to each space. Each chamber of the specific gas storage section 70 and each space in the optical path space LS are also respectively connected by the exhaust duct which exhausts the gas GS in each space.

FIG. 1 shows the condition with the specific gas storage section 70 connected to the space 30b Ducts for connecting the specific gas storage section 70 to other spaces are not shown.

The respective air supply ducts comprise pumps P1 to P6 for feeding the specific gas GT1 stored in the specific gas storage section 70 to the optical path space LS, in response to instructions of the control unit CONT, and air supply valves 11, 13, 15a, 15b, 15c and 17 for adjusting the quantity of the specific gas GT1 to be supplied to the optical path space LS by opening or closing the valves, in response to instructions of the control unit CONT. The respective exhaust ducts comprise exhaust valves 12, 14, 16a, 16b and 16c for adjusting the quantity of the gas GS to be exhausted from the respective spaces in the optical path space LS to respective chambers of the specific gas storage section 70.

These are provided so that the concentrations of the respective absorptive substances in the spaces of the illumination system housing 20, the mask chamber 5, the projection system housing 30 and the substrate chamber 6 are reduced independently by the gas replacement apparatus R.

For example, when the absorptive substance in the space 30b of the projection system housing 30 is to be reduced, the air supply valve 15b provided at one end of the space 30b, the exhaust valve 16b provided at the other end of the space 30b, and the pump P4 are used. The air supply valve 15b, the exhaust valve 16b and the pump P4 are connected to the control unit CONT, and when replacement of the gas in the space 30b of the projection system housing 30 is to be carried out, the control unit CONT opens the air supply valve 15b and the exhaust valve 16b, and operates the pump P4. As a result, the specific gas GT1 stored in the specific gas storage section 70 is fed into the space 30b of the projection system housing 30 via the air supply duct, and the gas in the space 30b is exhausted via the exhaust valve 16b, and returned to the specific gas storage section 70 via the exhaust duct.

For the other spaces of the optical path space LS, the reducing operation of the absorptive substance is carried out similarly by controlling the pump and each valve.

In each exhaust duct is arranged an air filter (not shown) for removing dust (particles), such as a HEPA filter (High Efficiency Particulate Air Filter) or an ULPA filter (Ultra Low Penetration Air Filter), and a chemical filter (not shown) for removing absorptive substances such as oxygen or the like described above. Similarly, an air filter and a chemical filter (both not shown) are arranged in each air supply duct.

In the gas GS exhausted via the exhaust valve, small amount of impurities (including particles and absorptive substances) are contained, but the impurities in the gas returning to the specific gas storage section 70 via the exhaust duct are substantially removed, by the air filter and the chemical filter provided in the exhaust duct. On the other hand, the impurities in the specific gas GT1 supplied to the optical path space LS from the specific gas storage section 70 via the air supply duct are removed by the air filter and the chemical filter provided in the air supply duct. Therefore, even if the specific gas GT1 is circulated and used for a long period of time, an adverse effect on the exposure light EL hardly occurs.

The measuring apparatus A will be described, with reference to FIG. 1 and FIG. 2.

The measuring apparatus A comprises; a measuring section M capable of measuring an absorptive substance, a predetermined gas supply unit N capable of supplying the gas GS in the optical path space LS to the measuring section M, a clean gas supply unit (specific gas supply unit) H capable of supplying a clean gas (specific gas) GT2 to the measuring section M, and a switchover device B which can switch the gas supply to the measuring section M, between from the predetermined gas supply unit N and from the clean gas supply unit H.

The measuring section M is capable of measuring an optional substance, and in this embodiment, is capable of measuring the concentration of oxygen, of the absorptive substances. The measuring section M may be for measuring whether an optional substance exists in the predetermined gas, instead of measuring the concentration of the optional substance. For this measuring section M, various kinds of oxygen concentration sensor, as represented by, for example, a zirconia type oxygen concentration sensor, can be used. Of these, the zirconia type oxygen concentration sensor uses the property of ionic conduction. This ionic conduction is a property where a zirconia ceramic formed with electrodes on opposite sides, ionizes oxygen molecules with one electrode under a high temperature condition, and restores the oxygen ions to oxygen molecules with the other electrode section, and the degree of the ionic conduction increases with an increase in the difference between the oxygen concentration of the gases existing on the opposite sides of the zirconia ceramic. At this time, electrons are transferred between the opposite electrodes, and the degree of ionic conduction (that is, the difference of the oxygen concentration on the opposite sides of the zirconia ceramic) can be taken out as the magnitude of the electromotive force between the opposite electrodes. Specifically, a gas having a constant oxygen concentration is disposed as a reference gas outside of a tube of the zirconia ceramic formed in a tubular shape, and a gas to be measured is disposed inside of the tube. As a result, ionic conduction occurs from the higher side to the lower side of the oxygen concentration, so that the oxygen concentration can be measured. The electromotive force changes depending on the temperature of the zirconia sensor and the oxygen concentration in the reference gas. Therefore, the zirconia sensor is installed in a thermostatic oven, and atmospheric air is generally used as the reference gas.

Alternatively, there may be used an oxygen concentration sensor capable of measuring oxygen concentration based on the principle of a battery, where oxygen in the gas to be measured is reduced at the time of passing through an electrochemical cell.

The predetermined gas supply unit N is for supplying the gas GS in the optical path space LS to the measuring section M, and comprises a duct 91 branched toward the measuring section M (switchover device B) from the exhaust duct heading toward the specific gas storage section 70 from the optical path space LS, a valve 90 provided in the duct 91 and a pump (not shown). In FIG. 2, the duct 91 is only shown for part of the optical path space LS, branched from the exhaust duct arranged from the projection system housing 20 towards the first chamber of the specific gas storage section 70. However, ducts (not shown) heading towards the measuring section M from the other five exhaust ducts are also branched, and valves are respectively provided with respect to the respective ducts. The gas GS in the optical path space LS is supplied to the measuring section M via the switchover device B, by the predetermined gas supply unit N having the duct 91 and the valve 90.

The clean gas supply unit H is for supplying the clean gas GT2 to the measuring section M, and for supplying a gas in which the substance to be measured by the measuring section M is sufficiently reduced, as described above. In this embodiment, since the substance to be measured by the measuring section M is oxygen, a gas in which the oxygen concentration is sufficiently reduced, for example, an inert gas such as nitrogen, helium, argon, neon or krypton, or a mixture gas thereof, is used as the clean gas GT2. The clean gas supply unit H comprises; a clean gas storage section (inert gas storage section) 92 which stores the clean gas (inert gas) GT2, a duct 93 arranged from the clean gas storage section 92 towards the measuring section M (switchover device B), a valve 94 provided in the duct 93 and a pump (not shown) for feeding the clean gas GT2 from the clean gas storage section 92 to the duct 93.

The switchover device B is a switching valve provided between the duct 91 for the predetermined gas supply unit N and the duct 93 for the clean gas supply unit H, and by switching the channels of the gas from the respective ducts 91 and 93, supply to the measuring section M of the gas GS in the optical path space LS by the predetermined gas supply unit N and supply of the clean gas GT2 from the clean gas supply unit H can be switched over. The switchover device B operates based on instructions from the control unit CONT.

The measurement result of the measuring section M is transmitted to the control unit CONT, as well as being displayed by a display section (not shown).

A measuring method for measuring the absorptive substance contained in the gas GS in the optical path space LS by the measuring apparatus A having the above described construction, and an exposure method for transferring an image of the pattern formed on the mask MS onto the substrate P by the exposure apparatus body E will now be described.

The measuring method and the exposure method of the present invention comprise; a step for reducing the absorptive substance in the optical path space LS (step 1), a step for supplying the clean gas GT2 from the clean gas supply unit (an inert gas supply unit) H to the measuring section M (step 2), a step for supplying the gas GS in the optical path space LS from the gas supply unit N to the measuring section M to which the clean gas GT2 has been supplied in step 2 (step 3), a step for switching the supply of the clean gas GT2 and the supply of the gas GS in the optical path space LS (step 4), and a step for transferring an image of a pattern formed on the mask MS to the substrate P, after the concentration of the absorptive substance in the optical path space LS becomes less than a predetermined value.

In the description below, the operation for reducing the absorptive substance in the optical path space LS by the gas replacement apparatus R is appropriately referred to as a “purge operation”, and the operation for supplying the clean gas GT2 to the measuring section M is referred to as a “cleaning operation”.

<Step 1>

At first, the mask MS is held on the mask holder 51, and the substrate P is held on the substrate holder 61.

The operation (purge) for reducing the absorptive substance existing in the optical path space LS of the exposure light EL, in the exposure apparatus body E, is carried out by the gas replacement apparatus R. That is to say, the respective pumps P1 to P6 of the gas replacement apparatus R are operated, and each of the air supply valves 11, 13, 15a, 15b, 15c and 17, and each of the exhaust valves 12, 14, 16a, 16b, 16c and 18 are opened to exhaust the gas GS in the optical path space LS, and supply the purge gas GT1 from the specific gas storage section 70 to the optical path space LS. At this time, the valve 90 provided in the duct 91 of the gas supply unit N is closed, so that the gas GS in the optical path space LS is not fed to the measuring section M side (the switchover device B).

<Step 2>

While the purge operation in the optical path space LS is being carried out, the clean gas GT2 is supplied from the clean gas supply unit H to the measuring section M. That is to say, the pump (not shown) in the clean gas supply unit H is operated and the valve 94 is opened. At this time, the control unit CONT instructs the switchover device B (switching valve) to block off the channel from the gas supply unit N to the measuring section M and open the channel from the clean gas supply unit H to the measuring section M.

A construction is also possible where the valve 94 is not provided, and the channel from the clean gas supply unit H to the switchover device B is open so that the clean gas GT2 can flow all the time. In this case, supply of the gas to the measuring section M is controlled by the switchover device B.

The measuring section M is then filled with the clean gas GT2 supplied from the clean gas supply unit H. The concentration of the absorptive substance (oxygen) existing in the measuring section M is reduced by the supplied clean gas GT2. That is to say, when the measuring section M is exposed to atmospheric air, for example, at the time of startup of the apparatus after shipment or at the time of maintenance, the absorptive substance stays in the measuring section M, but by supplying the clean gas GT2, the absorptive substance is exhausted to outside of the measuring section M, and hence the concentration of the absorptive substance existing in the measuring section M is reduced. A pump may be provided in the measuring section M to forcibly exhaust the gas in the measuring section M.

In this manner, the operation for reducing the absorptive substance in the optical path space LS is performed, and the clean gas GT2 is supplied to the measuring section M. The supply of the clean gas GT2 to the measuring section M is carried out until the measurement of concentration of the absorptive substance (oxygen) measured by the measuring section M becomes a predetermined value.

Here, the predetermined value is a value preset so that the concentration of the absorptive substance in the optical path space LS can be measured at a predetermined accuracy or higher, being a value of a concentration judged by the control unit CONT at which appropriate measurement of concentration of the absorptive substance in the optical path space LS can be performed.

That is to say, when the target accuracy of concentration of the absorptive substance in the optical path space LS, desired to be measured, is for example 100 ppm, it is necessary to make the concentration of the absorptive substance remaining in the measuring section M no more than 100 ppm. In this case, the predetermined accuracy of concentration is 100 ppm, and the predetermined value is a value lower than 100 ppm (for example, 10 ppm). Therefore, if the measurement at the time of cleaning of the measuring section M shows the predetermined value (10 ppm), measurement can be carried out at high accuracy, when the gas OS in the optical path space LS is supplied to the measuring section M. In this case, the predetermined value need not be a constant.

In the control unit CONT is pre-stored a plurality of data relating to appropriately measurable concentrations, for when the predetermined value is optionally changed. The control unit CONT judges whether concentration measurement is possible at a desired accuracy, based on the plurality of data (data table) and the measurement result of the measuring section M.

The predetermined value can be obtained by experiments beforehand. If cleaning is carried out until the measurement becomes the predetermined value or less, the concentration of the absorptive substance in the optical path space LS can be stably measured. If the measurement is the predetermined value or higher, there is a problem in that for example, the concentration of the absorptive substance in the optical path space LS gives a measurement result which is higher than the true value.

Alternatively, it is possible to perform simulation based on the properties of the measuring section M, and obtain the predetermined value at which the desired measurement accuracy can be obtained, from the simulation result.

The control unit CONT performs the cleaning operation while referring to the above described data table, and when it judges that the measurement is less than the predetermined value, it judges this to be a condition where appropriate measurement can be performed, and instructs the switchover device B to perform a predetermined operation.

<Step 3>

The clean gas GT2 is supplied to the measuring section M, and when the measurement of concentration of the absorptive substance by the measuring section M becomes lower than the predetermined value, the control unit CONT instructs the switchover device B to open the channel from the gas supply unit N to the measuring section M, and block off the channel from the clean gas supply unit H to the measuring section M. The gas GS in the optical path space LS is then supplied to the measuring section M by the gas supply unit N. The measuring section M measures the concentration of the absorptive substance (oxygen) in the optical path space LS at this time, from the supplied gas GS in the optical path space LS. Since the clean gas GT2 has been supplied beforehand to the measuring section M, the concentration of the absorptive substance (oxygen) in the measuring section M is reduced. Therefore, the concentration of the absorptive substance (oxygen) in the optical path space LS can be measured accurately.

As described above, the cleaning operation is performed for the measuring section B, while performing purge in the optical path space LS, and by supplying the gas GS in the optical path space LS to the cleaned measuring section M at a predetermined point in time, the concentration of the absorptive substance existing in the optical path space LS can be measured accurately.

<Step 4>

In the case where the concentration of the absorptive substance in the optical path space LS is measured while performing the purge operation for the optical path space LS, supply to the measuring section M of the clean gas GT2 and of the gas GS in the optical path space LS are alternately carried out for a predetermined number of times, in order to understand the situation of changes in the concentration of the absorptive substance in the optical path space LS which occur due to the purge operation, and to measure the concentration of the absorptive substance accurately, even in the low concentration region.

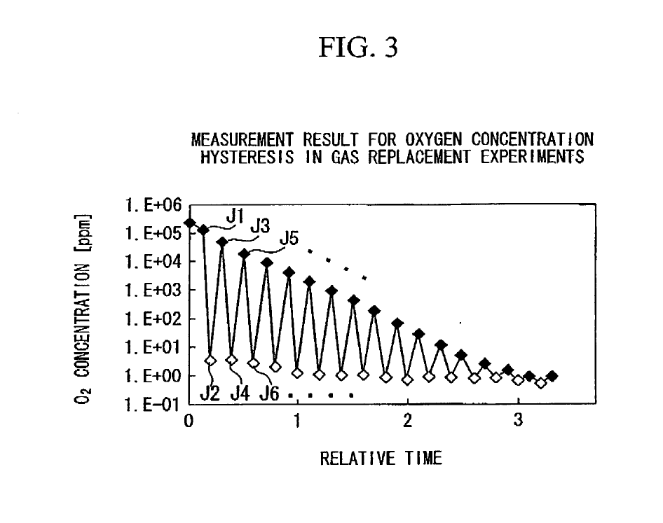

That is to say, the operation for supplying the clean gas GT2 to the measuring section M until the measurement shows a predetermined value or less (see the white circle in FIG. 3), the operation for supplying the gas GS in the optical path space LS by operating the switchover device B, at the point in time when the measurement becomes lower than the predetermined value, to measure the concentration of the absorptive substance (see the black circle in FIG. 3), and the operation for cleaning the measuring section M by operating the switchover device B again, are repeated alternately.

Here, explanation will be given for FIG. 3. The graph shown in FIG. 3 is for explaining the situation where the concentration of the absorptive substance to be measured (hereinafter, oxygen concentration is shown as an example) is changed by performing the cleaning operation, the Y axis showing the oxygen concentration and the X axis showing time (relative time). Point J1 shown by a black circle in this figure is a measurement result for oxygen concentration, when the gas GS in the optical path space LS is supplied, being the initial state where purge has not yet been performed for the measuring section M by the gas supply unit N, and it indicates an oxygen concentration substantially the same as atmospheric air. The switchover device B is then operated to perform cleaning of the measuring section M. Hence the oxygen concentration is reduced, as shown by point J2 shown by a white circle. The target oxygen concentration (predetermined value) at this time is set according to the target accuracy at point J3 to be measured next. That is to say, if the concentration at point J2 is set sufficiently low with respect to the concentration at point J3, the oxygen concentration at this point J3 can be measured accurately.

In FIG. 3, the target oxygen concentration at the time of cleaning is 1 ppm, but just after starting gas replacement, such as at points J2, J4, . . . , it is not always necessary to make the oxygen concentration 1 ppm or below. That is to say, the oxygen concentration at point J2 may be a value so small as to be ignored compared to that at point J3, or a predetermined value so that the oxygen concentration at point J3 can be measured accurately. Therefore, the clean gas GT2 supplied from the clean gas supply unit H may have an oxygen concentration less than the detection resolution for the oxygen concentration in the measuring section M. That is to say, when an optional substance contained in the predetermined gas GS is to be measured, a gas which does not contain the optional substance may be used for the clean gas GT2, or a gas in which the concentration of the optional substance has been reduced to below a predetermined value may be used for the clean gas GT2.

After the oxygen concentration at point J3 is measured, cleaning of the measuring section M is performed again. Then, the measurement result showing low oxygen concentration as shown at point J4 is obtained. Thereafter, supply of the clean gas GT2 and supply of the gas GS in the optical path space LS to the measuring section M are repeated alternately. At this time, since the optical path space LS undergoes the purge operation continuously, values at points J1, J3, J5, . . . , shown by black circles, which are the results of concentration measurement of oxygen in the optical path space LS, gradually decrease. Similarly, the oxygen concentration at points J2, J4, J6, . . . , shown by white circles, which are the results of measurement at the time of cleaning (at the time of supplying the inert gas), gradually decrease, depending on the oxygen concentration at points J1, J3, J5, . . . .

As described above, changes in oxygen concentration in the optical path space LS to be purged can be accurately measured, as shown at points J1, J3, J5, . . . . Moreover, accurate concentration measurement becomes possible also in the low concentration region (for example, 1 ppm). That is to say, before measuring the oxygen concentration in the optical path space LS in the predetermined state by the measuring section M, the cleaning operation is carried out for the measuring section M, to thereby greatly reduce the residual oxygen concentration in the measuring section M. By measuring the oxygen concentration in the optical path space LS in this state, an accurate measurement result can be obtained. At this time, oxygen and other absorptive substances may be contained in the clean gas GT2, if these are less than the measurement limit of the oxygen concentration measured by the measuring section M in the low concentration region, and the clean gas GT2 may contain the absorptive substance of less than the predetermined value depending on the target measurement accuracy. In other words, for the clean gas GT2, not only a gas which does not contain an optional substance may be used, but also a gas in which the concentration of the optional substance is reduced to less than a predetermined value may be used, and oxygen may also be contained if the amount thereof is very small.

<Step 5>

In this manner, after the purge operation has been carried out for the optical path space LS, and it has been confirmed that the oxygen concentration in the optical path space LS less than the predetermined value by the measuring apparatus A, the control unit CONT instructs the exposure apparatus body E to transfer an image of a pattern formed on the mask MS to the substrate P. The substrate P then undergoes stable exposure processing under the environment in which the absorptive substance is reduced.

The predetermined value in this is a value of oxygen concentration in the optical path space LS, at which appropriate transfer can be performed. If the oxygen concentration is less than this predetermined value, desired transfer accuracy can be obtained, when the image of the pattern formed on the mask MS is transferred to the substrate P. This predetermined value can be determined beforehand by experiments or the like. That is to say, a relation between the oxygen concentration at which the image of the pattern on the mask MS can be normally transferred onto the substrate P and data of the intensity of the exposure light (including the illuminance distribution) to be guided to the substrate P is determined beforehand, and based on this relation, the control unit CONT controls the state for transferring the image of the pattern on the mask MS onto the substrate P.

As described above, when the oxygen concentration in the optical path space LS is measured by the measuring section M, the clean gas GT2, in which the oxygen concentration has been reduced, is supplied to the measuring section M, to thereby reduce the concentration of oxygen remaining in the measuring section M. By supplying the predetermined GS to the measuring section M in which the oxygen concentration has been reduced, the oxygen concentration can be measured accurately and promptly, thereby improving the reliability of the obtained measurement data. The conditions of the optical path space LS, for example, whether the optical path space LS is in a normal state capable of carrying out the transfer processing, can be determined accurately and promptly, without being affected by the residual oxygen concentration in the measuring section M. As a result, stable exposure processing can be performed with high working efficiency.

At this time, by alternately supplying the gas GS in the optical path space LS and the clean gas GT2, to the measuring section M, accurate measurement can be performed efficiently within a short period of time in all concentration regions, even in a low concentration region where the oxygen concentration contained in the gas GS is very low. Moreover, even when the oxygen concentration in the optical path space LS changes due to purging, the oxygen concentration at that point in time of measurement can be measured accurately. For the substances to be measured by the measuring section M, not only the concentration of the above described one substance (oxygen), but also that of all absorptive substances, such as oxygen, water vapor, hydrocarbon gas and the like may be measured.

As described above, the concentration of the absorptive substance in the predetermined gas GS can be measured accurately and promptly, by alternately performing the cleaning operation for the measuring section M and supply of the predetermined gas GS (gas in the optical path space LS). In one cleaning operation, changes in concentration of the absorptive substance in the optical path space LS cannot be monitored, but by alternately performing the cleaning operation and the concentration measurement of the absorptive substance in the optical path space LS, changes in concentration of the absorptive substance in the optical path space LS can be measured, while performing the purge operation. Therefore, the condition in the optical path space LS can be accurately understood, as well as avoiding excessive purge operation, thereby enabling efficient operation. Moreover, the life of the measuring section M can be extended, thereby reducing the running cost.

By supplying the clean gas GT2 to the measuring section M, and when the measurement of the concentration of the absorptive substance becomes lower than a predetermined value, supplying the gas GS in the optical path space LS, concentration measurement of the absorptive substance can be efficiently performed depending on desired measurement accuracy. That is to say, for example, when it is desired to measure a concentration of 10 ppm, the clean gas GT2 may be supplied to the measuring section M, and when the measurement thereof becomes 10 ppm or below, the supply of the clean gas GT2 may be stopped, and the gas GS in the optical path space LS may be supplied. At this time, as described above, the supply of the clean gas GT2 at the time of cleaning is not necessarily continued to 10 ppm or below, in the initial stage of gas replacement. In this manner, the clean gas GT2 may be supplied depending on the target measurement accuracy, and hence excessive supply of the clean gas GT2 can be avoided, thereby enabling efficient measurement. In this case, an absorptive substance may be contained in the clean gas GT2 in an amount less than the predetermined value, so long as the amount thereof is less than the measurement limit of the predetermined substance (absorptive substance) to be measured by the measuring section M.

In this embodiment, explanation has been given for the case where the clean gas GT2 is supplied to the measuring section M from the clean gas supply unit H, while performing the reduction operation (purge) of the absorptive substance in the optical path space LS. However, the clean gas GT2 may be supplied to the measuring section M after the purge operation has been performed for a predetermined period of time. The switchover of the gas channel by the switchover device B and the concentration measurement of the absorptive substance by the measuring section M may be carried out while performing the purge operation, or may be carried out after the purge operation is stopped.

In this embodiment, the construction is such that the cleaning operation for the measuring section M is carried out while performing the purge operation for the optical path space LS. However, the construction may be such that after the purge operation has been performed for the optical path space LS by the gas replacement apparatus R, the gas replacement apparatus R is stopped, and supply of the clean gas GT2 and supply of the gas GS in the optical path space LS, to the measuring section M are alternately carried out. That is to say, by carrying out cleaning for the measuring section M several times without performing the purge operation, the concentration of the absorptive substance in the optical path space LS at the point in time of performing the purge operation for a predetermined period of time can be accurately measured. In this case, the optical path space LS is kept in a sealed state.

In this embodiment, the gas replacement apparatus R supplies an inert gas GT1 to the optical path space LS, as well as exhausting the gas GS in the optical path space LS, to thereby reduce the absorptive substance. However, the inert gas may be supplied after the absorptive substance has been reduced by exhaust (vacuum evacuation) of the gas GS in the exposure light space LS.

In this embodiment, the clean gas supply unit H supplies an inert gas such as nitrogen, or argon, as a gas that does not contain an absorptive substance. However, when an object to be measured is not an absorptive substance, that is, an optional substance is to be measured, a gas (substance) which does not contain the optional substance or a gas (substance) in which the concentration of the optional substance has been reduced to a predetermined value or below is supplied.

The specific gas (purge gas) GT1 to be supplied to the optical path space LS by the gas replacement apparatus R, and the specific gas (clean gas) GT2 to be supplied to the measuring section M by the clean gas supply unit H may be the same kind of gas, or may be a different kind of gas. That is to say, the gas used for purge of the optical path space LS is required to be inert with respect to the vacuum ultraviolet rays, but the gas GT2 used for cleaning of the measuring section M is not necessarily inert with respect to the vacuum ultraviolet rays. In this embodiment, since the measuring section M is for measuring the oxygen concentration, the clean gas GT2 may be an absorptive substance such as carbon dioxide or hydrogen. Oxygen may be also contained, if the amount thereof is small. For the purge gas ST1 in the optical path space LS, there is used a gas which is inert with respect to VUV, a gas having a low absorptive property which does not cause a photochemical reaction, or a gas having no corrosiveness with respect to the members (the glass material, the lens holders, the internal wall of the body tube, and the coating material thereof). For the clean gas GT2, there is used a gas which does not contain an absorptive substance or a gas which does not have corrosiveness.

In this embodiment, the construction is such that one measuring section M is provided, and the supply of the gas GS to the measuring section M from the respective spaces 20, 50, 30a, 30b, 30c and 60 is separately carried out, by adjusting the respectively provided valves 90 via the ducts 91. For example, when it is desired to measure the concentration of the absorptive substance in the space 30b, the valves 90 of the ducts 91 connected to the respective spaces 20, 50, 30a; 30c and 60 are closed. When it is desired to measure the concentration of the absorptive substance in all the spaces 30a, 30b and 30c, the valves 90 of the ducts 91 connected to the respective spaces 20, 50 and 60 are closed. On the other hand, it is also possible to provide a plurality of (six) measuring sections M, so that measurement of the absorptive substance in the respective spaces is carried out separately at the same time. In this case, one clean gas supply unit H is provided, and the ducts 93 are connected to the respective measuring sections M, so that the clean gas GT2 is supplied by adjusting the valves 94 respectively provided. It is also possible to provide a plurality of (six) clean gas supply units H, and to install the clean gas supply units H respectively for the plurality of measuring sections M. The specific gas supply section 70 is divided here into the first chamber to the sixth chamber, but the specific gas may be supplied from one chamber to the respective spaces 20 to 60.

When measurement of the concentration of the absorptive substance in the optical path space LS is not carried out, such as during exposure processing, it is desirable to maintain the supply of the clean gas GT2 to the measuring section M by the clean gas supply unit H, with the channel on the gas supply unit N side blocked off by the switchover device B, so that the clean state can be maintained all the time.

In this embodiment, the construction is such that the control unit CONT judges whether a measurement of the measuring section M is less than a predetermined value at the time of cleaning, and based on this judgment result, the control unit CONT instructs the switchover device B. However, for example an operator may switch the switchover device B manually, based on information on a display section (not shown).

When the gas GS in the optical path space LS is supplied to the measuring section M, changes in the introduction pressure of the gas may affect the measurement result. Therefore, during measurement, it is desirable to fix the pressure of the gas supply to the measuring section M by the gas supply unit N, to a certain value.

When the gas OS in the optical path space LS is supplied after the clean gas GT2 has been supplied to the measuring section M, a measurement of concentration of the absorptive substance in the gas GS may be measured lower than the true value, due to the clean gas GT2 supplied before. Therefore, a time commensurate with the time required until the measurement becomes stable at the time of supplying the clean gas GT2, is set for when the gas GS in the optical path space LS is supplied to the measuring section M.

In this embodiment, the construction is such that supply of the clean gas GT2 and supply of the gas GS in the optical path space LS, to the measuring section M, are alternately carried out in order to monitor the concentration of the absorptive substance (oxygen concentration) in the optical path space LS from the atmospheric air level. However, if the oxygen concentration is not monitored from the atmospheric air level, the switchover operation between the gas GS and the clean gas GT2 need not be performed. If the switchover operation is not carried out, the clean gas GT2 is supplied to the measuring section M continuously before starting the purge operation, to reduce the oxygen concentration in the measuring section M to a sufficient low level, and after the purge operation has been started, supply of the clean gas GT2 to the measuring section M is continued. After a certain period of time has passed so that it is judged that the oxygen concentration in the optical path space LS has been reduced to about 10 ppm, the gas GS in the optical path space LS is guided to the measuring section M, to measure the oxygen concentration. The above described certain period of time is a time determined by experiments or simulation beforehand, such that it can be expected that the oxygen concentration in the optical path space LS has become less than several tens ppm.

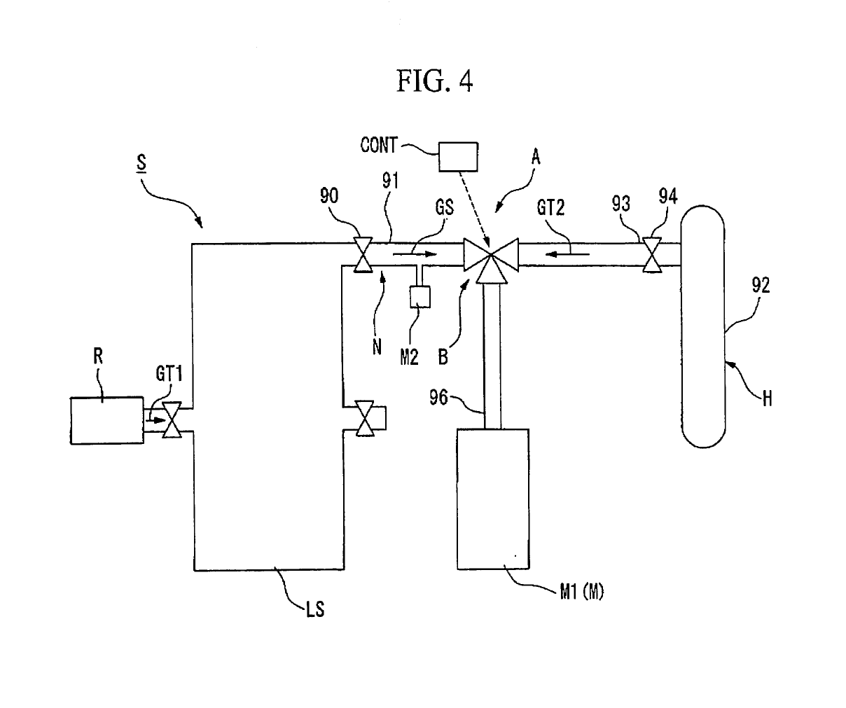

Moreover, rather than judging the certain period of time, the construction may be such that, as shown in FIG. 4, the oxygen concentration in the optical path space LS is monitored by using another measuring section M2, and after it is confirmed that the oxygen concentration has become several tens ppm, the gas GS in the optical path space LS is introduced to the measuring section M1 (M) in which the oxygen concentration has been reduced sufficiently by continuously flowing through the clean gas GT2 beforehand. The measuring section M2 which monitors the oxygen concentration from the atmospheric air level to several tens ppm may be the same as the measuring section M1, or may be different (for example, having a rough measurement accuracy compared to that of the measuring section M1). The number of the measuring sections M2 may be more than one.

In this embodiment, it has been described that when gas switchover is to be performed as shown in FIG. 3, the concentrations at points J2, J4, . . . are monitored, and once the concentration has become less than a predetermined value, the gas GS is taken in. However, the switchover timing may be such that a certain time interval is determined, and switchover is carried out periodically. This switchover timing is determined beforehand by experiments or the like.

Furthermore, after the clean gas GT2 has been supplied to the measuring section M, when as a result of measurement of the predetermined gas GS to be supplied from the optical path space LS, it is judged that the measurement accuracy of the measuring section M has sufficiently reached the measurement accuracy for the concentration of the target absorptive substance, it is not necessary to alternately carry out supply of the clean gas GT2 and supply of the predetermined gas GS to the measuring section M.

In this case, the absorptive substance remaining in the measuring section M is reduced by one supply of the clean gas GT2

Second Embodiment:

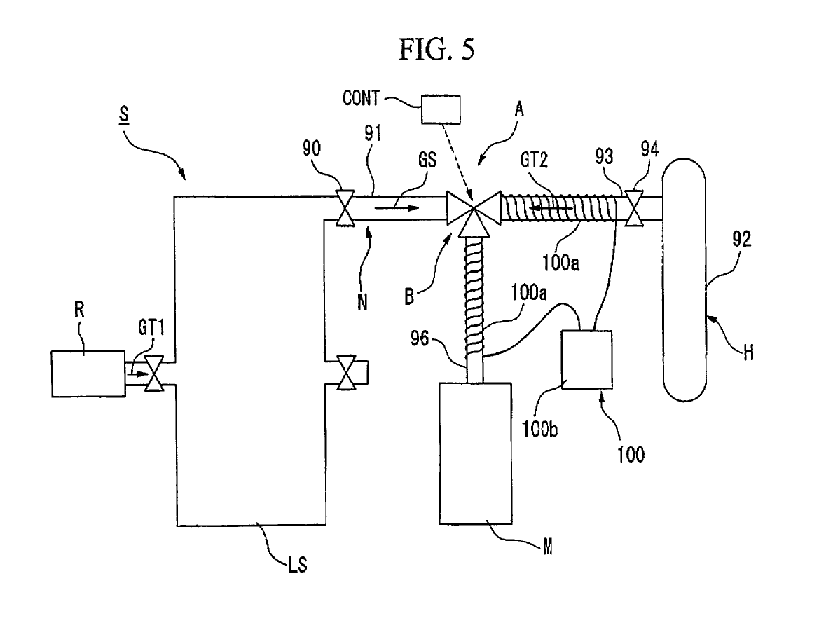

A second embodiment of the measuring apparatus and the exposure apparatus of the present invention will be described with reference to FIG. 5. Here the same or equivalent components as those in the first embodiment are denoted by the same reference symbols, and description thereof is simplified or omitted.

In FIG. 5, an exposure apparatus S comprises; a gas replacement apparatus R which reduces an absorptive substance in an optical path space LS, a measuring section M capable of measuring the absorptive substance, a gas supply unit N which can supply a gas GS in the optical path space LS to the measuring section M, a clean gas supply unit H which can supply a clean gas GT2 to the measuring section M, a switchover device B which can switch the supply of the respective gases to the measuring section M between from the gas supply unit N and from the clean gas supply unit H, and a heating apparatus 100 which can heat a duct 93 which connects an inert gas storage section 92 of the clean gas supply unit H to the switchover device B, and a duct 96 which connects the switchover device B to the measuring section M. In FIG. 5, the optical path space LS is simplified.

In this embodiment, a substance to be measured (absorptive substance) is water (water vapor). When water (water vapor) is the substance to be measured, sufficient measurement is possible with the first embodiment described above. Here, explanation is given as an embodiment for improvement, where water (water vapor) is measured more reliably. A water densitometer (dew point recorder) capable of measuring moisture is used herein for the measuring section M. The heating apparatus 100 comprises heating wires 100a wound around the duct 93 and the duct 96, and a power source 100b which heats the duct 93 and the duct 96 to a predetermined temperature, by supplying heat to the heating wires 100a. Therefore, the duct connecting the clean gas storage section 92 of the clean gas supply unit H to the measuring section M is heated by the heating apparatus 100. The clean gas GT2 stored in the clean gas storage section 92 is a gas in which moisture is reduced, or which does not contain moisture.

In order to measure the absorptive substance (in this case, moisture) in the optical path space LS by the measuring apparatus A having the above described construction, the clean gas GT2 in which the moisture is reduced is supplied to the measuring section M from the clean gas supply unit H in the same manner as in the first embodiment. In the measuring section M, the residual moisture is reduced by the supply of the clean gas GT2.

At this time, the duct 93 and the duct 96 are heated by the heating apparatus 100. Since moisture adhered to the duct 93 and the duct 96 is reduced by this heating, the clean gas GT2 to be supplied to the measuring section M through the ducts is supplied to the measuring section M, with the moisture reduced. Since moisture has a property of strongly adhering to the duct, different from oxygen or the like, then by heating the ducts by the heating apparatus 100, any moisture can be effectively removed.

In this manner, after the clean gas GT2 has been supplied to the measuring section M and the residual moisture concentration in the measuring section M reduced, the gas GS in the optical path space LS is supplied to the measuring section M by the gas supply unit N, to thereby measure the moisture concentration. As in the first embodiment, supply of the clean gas GT2 and supply of the gas GS in the optical path space LS to the measuring section M, is alternately carried out to measure the concentration of the absorptive substance (moisture) in the optical path space LS.

As described above, even if the kind of the absorptive substance to be measured is different, the concentration of the absorptive substance can be stably measured.

In this embodiment, the construction is such that moisture adhering to the ducts is reduced by heating, but it is also possible to vibrate the ducts (or the measuring section M) by using for example supersonic waves, to reduce the moisture by vibration. Alternatively, moisture in the ducts can be reduced by heating the clean gas GT2 to a temperature sufficient for reducing thc moisture in the ducts, and flowing this high-temperature clean gas GT2 through the ducts.

Third Embodiment:

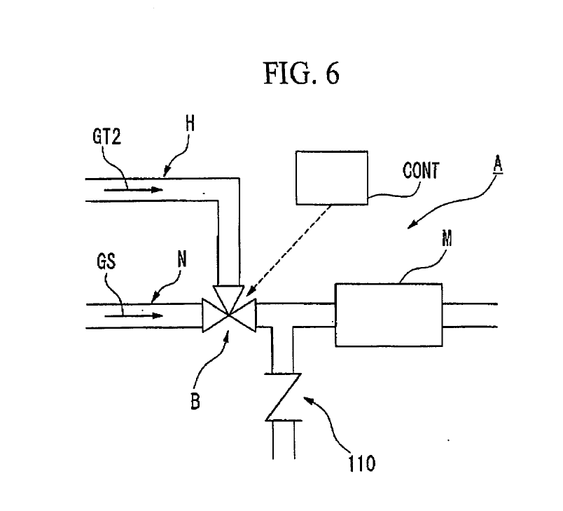

A third embodiment of a measuring apparatus of the present invention will be described with reference to FIG. 6. Here the same or equivalent components as those in the first embodiment and the second embodiment are denoted by the same reference symbols, and description thereof is simplified or omitted.

In FIG. 6, a measuring apparatus A comprises; a measuring section M capable of measuring an optional substance contained in a predetermined gas GS supplied from a optical path space LS, a predetermined gas supply unit N which can supply the predetermined gas GS to the measuring section M, a clean gas supply unit 14 which can supply a clean gas GT2, in which the concentration of the optional substance is reduced, to the measuring section M, a switchover device B (for example, a three-way valve) which can switch the supply of the respective gases to the measuring section M between from the predetermined gas supply unit N and from the clean gas supply unit H, and a control unit CONT which operates the switchover device B. A check valve 10 is installed in a duct connecting the switchover device B and the measuring section M, for reducing excessive pressure acting on the measuring section M due to the gas supplied to the measuring section M.

When an optional substance contained in the predetermined gas GS is measured using this measuring apparatus A, the clean gas GT2 is first supplied to the measuring section M. In the measuring section M to which the clean gas GT2 has been supplied, any residual substances are reduced. When a measurement of the concentration of the optional substance by the measuring section M becomes lower than a predetermined value, the control unit CONT operates the switchover device B. The predetermined gas GS is then supplied to the measuring section M in which the residual concentration of the substance has been reduced. The measuring section M measures the concentration of the substance to be measured (optional substance) contained in the predetermined gas GS. Then supply of the predetermined gas GS and supply of the clean gas GT2 to the measuring section M are alternately repeated by the switchover device B, until the measurement of the measuring section M becomes stable, to thereby measure the concentration of the substance to be measured, which is contained in the predetermined gas GS.

As described above, in addition to the case where the measuring section M is applied to measurement of an absorptive substance in the control unit CONT, the measuring apparatus A can be applied to a case where an optional substance is to be measured. By alternately carrying out supply of the predetermined gas GS and supply of the clean gas GT2 to the measuring section M, the optional substance in the predetermined gas GS can be measured, while reducing the optional substance remaining in the measuring section M. As a result, the concentration of the optional substance can be measured accurately and promptly even in a low concentration region.

Fourth Embodiment:

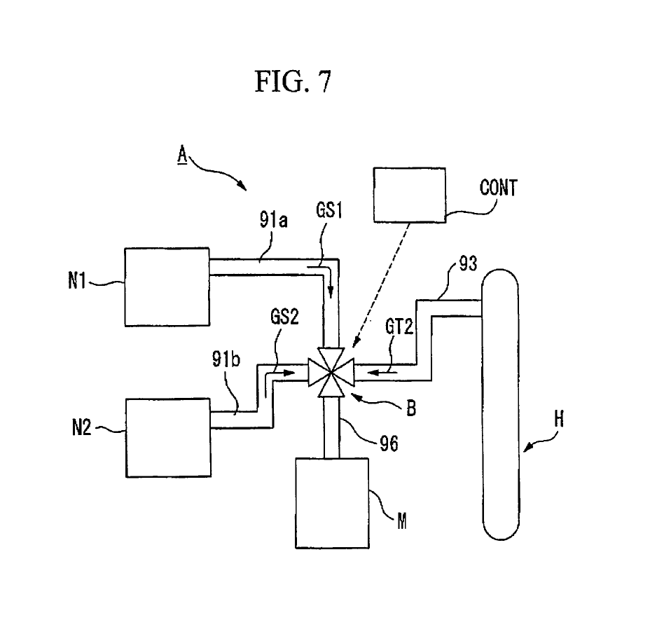

A fourth embodiment of a measuring apparatus of the present invention will be described with reference to FIG. 7. Here the same or equivalent components as those in the first, second and third embodiments are denoted by the same reference symbols, and description thereof is simplified or omitted.

In FIG 7, a measuring apparatus A comprises; a measuring section M capable of measuring an optional substance (substance to be measured), a first predetermined gas supply unit N1 which can supply a first predetermined gas GS1 to the measuring section M, a second predetermined gas supply unit N2 which can supply a second predetermined gas GS2 to the measuring section M, a clean gas supply unit H which can supply a clean gas GT2, in which the concentration of the substance to be measured is reduced, to the measuring section M, a switchover device B which can switch the supply of the respective gases to the measuring section M between from the first and second predetermined gas supply units N1 and N2, and from the clean gas supply unit H, and a control unit CONT which operates the switchover device B for a predetermined number of times.

The first predetermined gas GS1 contains the substance to be measured in a predetermined concentration. The second predetermined gas GS2 also contains the same substance to be measured as that contained in the fist predetermined gas GS1, in a predetermined concentration. The concentration of the substance to be measured in the second predetermined gas GS2 may be the same as or different from the concentration of the substance to be measured contained in the first predetermined gas.

A method of measuring the concentration of the substance to be measured respectively contained in the first and second predetermined gases GS1 and GS2 by the measuring apparatus A having the above described construction will be described below.

The control unit CONT operates the switchover device B so as to block off a channel connecting the first predetermined gas supply unit N1 to the measuring section M, and a channel connecting the second predetermined gas supply unit N2 to the measuring section M, and to open a channel connecting the clean gas supply unit H to the measuring section M. The clean gas GT2 with the concentration of the substance to be measured reduced is supplied to the measuring section M. In the measuring section M, the residual substance to be measured is reduced by the supply of the clean gas GT2.

When the concentration of the substance to be measured remaining in the measuring section M is reduced to below a predetermined value by supplying the clean gas GT2, the control unit CONT operates the switchover device B so as to open the channel connecting the first predetermined gas supply unit N1 to the measuring section M, and to block off the channel connecting the second predetermined gas supply unit N2 to the measuring section M and the channel connecting the clean gas supply unit H to the measuring section M. As a result, the first predetermined gas GS1 is supplied from the first predetermined gas supply unit N1, and the measuring section M measures the concentration of the substance to be measured contained in the first predetermined gas GS1.

Next, the control unit CONT again operates the switchover device B so as to block off the channel connecting the first predetermined gas supply unit N1 to the measuring section M and the channel connecting the second predetermined gas supply unit N2 to the measuring section M, and to open the channel connecting the clean gas supply unit H to the measuring section M. The clean gas GT2 with the concentration of the substance to be measured reduced is supplied to the measuring section M. In the measuring section M, the residual substance to be measured is reduced by supplying the clean gas GT2.

When the concentration of the substance to be measured remaining in the measuring section M is reduced to below a predetermined value by supplying the clean gas GT2, the control unit CONT operates the switchover device B so as to open the channel connecting the second predetermined gas supply unit N2 to the measuring section M, and to block off the channel connecting the first predetermined gas supply unit N1 to the measuring section M and the channel connecting the clean gas supply unit H to the measuring section M. As a result, the second predetermined gas GS2 is supplied from the second predetermined gas supply unit N2, and the measuring section M measures the concentration of the substance to be measured contained in the second predetermined gas GS2.

Next, the control unit CONT operates the switchover device B so as to block off the channel connecting the first predetermined gas supply unit N1 to the measuring section M and the channel connecting the second predetermined gas supply unit N2 to the measuring section M, and to open the channel connecting the clean gas supply unit H to the measuring section M. The clean gas GT2 with the concentration of the substance to be measured reduced is supplied to the measuring section M. In the measuring section M, the residual substance to be measured is reduced by supplying the clean gas GT2.

When the concentration of the substance to be measured remaining in the measuring section M is reduced to below a predetermined value by supplying the clean gas GT2, the control unit CONT operates the switchover device B so as to open the channel connect the first predetermined gas supply unit N1 to the measuring section M, and to block off the channel connecting the second predetermined gas supply unit N2 to the measuring section M and the channel connecting the clean gas supply unit H to the measuring section M. As a result, the first predetermined gas GS1 is supplied from the first predetermined gas supply unit N1, and the measuring section M measures the concentration of the substance to be measured contained in the first predetermined gas GS2.

Next, the control unit CONT operates the switchover device B so as to block off the channel connecting the first predetermined gas supply unit N1 to the measuring section M and the channel connecting the second predetermined gas supply unit N2 to the measuring section M, and to open the channel connecting the clean gas supply unit H to the measuring section M. The clean gas GT2 with the concentration of the substance to be measured reduced is supplied to the measuring section M. In the measuring section M, the residual substance to be measured is reduced by supplying the clean gas GT2.

When the concentration of the substance to be measured remaining in the measuring section M is reduced to below a predetermined value by supplying the clean gas GT2, the control unit CONT operates the switchover device B so as to open the channel connecting the second predetermined gas supply unit N2 to the measuring section M, and to block off the channel connecting the first predetermined gas supply unit N1 to the measuring section M and the channel connecting the clean gas supply unit H to the measuring section M. As a result, the second predetermined gas GS2 is supplied from the second predetermined gas supply unit N2, and the measuring section M measures the concentration of the substance to be measured contained in the second predetermined gas GS2.

Then the following operations from (1) to (4) are repeated, that is, (1) supply of the clean gas GT2 from the clean gas supply unit H to the measuring section M, (2) supply of the first predetermined gas GS1 from the first predetermined gas supply unit N1 to the measuring section M, (3) supply of the clean gas GT2 from the clean gas supply unit H to the measuring section M, (4) supply of the second predetermined gas GS2 from the second predetermined gas supply unit N2 to the measuring section M. In this manner by alternately carrying out supply of the gas GS1 from the first predetermined gas supply unit N1 and supply of the clean gas GT2 from the clean gas supply unit H, and by alternately carrying out supply of the gas GS2 from the second predetermined gas supply unit N2 and supply of the clean gas GT2 from the clean gas supply unit H, optional substances contained in the two predetermined gases GS1 and GS2 can be measured accurately at the same time.

In this embodiment, the predetermined gases (gases to be measured) are two kinds of gases, namely the first predetermined gas GS1 and the second predetermined gas GS2. However, two or more optional kinds of gases can be measured at the same time.

Moreover in this embodiment, the description has been made for the case where the substance to be measured contained in the first predetermined gas GS1 and the second predetermined gas GS2 is the same, but if the measuring section M can measure a plurality of substances, the kinds of the substance to be measured contained in the first predetermined gas GS1 and the second predetermined gas GS2 may be different.

In each of the first, second and third embodiments, the construction is for measuring the concentration of a substance, but the construction can be applied to a measuring method and a measuring apparatus for measuring various physical properties such as the kinds of substances.

In the above first, second and third embodiments, the kinds of the predetermined gas GS and the clean gas GT2 are different, but the kinds of the predetermined gas GS and the clean gas GT2 may be the same. That is to say, in the predetermined gas GS, when this gas GS (for example, nitrogen) contains an optional substance (for example, oxygen), a gas GS (nitrogen) may be used for the clean gas GT2, in which the optional substance (oxygen) is reduced or which does not contain the optional substance (oxygen).

In the above described each embodiment, the inside of the projection system housing 30 is divided into three spaces, that is, the spaces 30a, 30b and 30c, but this number of divisions is optional, or there may be no divisions. Moreover, the illumination system housing 20 is formed by one space, but the inside of the illumination system housing 20 may be divided into a plurality of spaces. For example, it is preferable to divide the inside of the illumination system housing 20 by a plurality of optical members (for example, optical members constituting the illumination optical system).

In the above described embodiments, the allowable temperature of the absorptive substance existing in the optical path space LS, consisting of the illumination system housing 20, the mask chamber 5, the projection system housing 30 and the substrate chamber 6 may be different for each space.

In each embodiment, it has been described that the gas GS exhausted from each optical path space LS is returned to the specific gas storage section 70 via an air filter or a chemical filter. However, it is not always necessary that the gas GS exhausted from each optical path space LS is returned to the specific gas storage section 70.

The ducts described in the above described embodiments are composed of piping having little accumulation and adsorption of impurities, such as the electrolytically polished internal walls of SUS.

The measuring method and the measuring apparatus of the present invention are applicable not only to measurement of oxygen molecules, water molecules and carbide, but also to measurement of substances such as ammonia compounds, Si based compounds (silane base compounds), halogenated compounds, NOx and SOx, and mixtures thereof.

The exposure apparatus in the above embodiments is also applicable to a scanning type exposure apparatus where a pattern of a mask MS is exposed while the mask MS and a substrate P are synchronously moved.

The exposure apparatus in the above embodiments is also applicable to a proximity exposure apparatus where a pattern of a mask MS is exposed by bringing a mask MS and a substrate P into close contact with each other, without using the projection optical system 3.

The application of the exposure apparatus S is not limited to the exposure apparatus for manufacturing semiconductors, and for example, the exposure apparatus is widely applicable to exposure apparatus for liquid crystals, where a pattern of a liquid crystal display device is exposed on a rectangular glass plate, or exposure apparatus for manufacturing thin film magnetic heads.

The magnification of the projection optical system may involve not only a reduction system but may also involve an equal magnification or enlarging system.

As the projection optical system 3, when a far-ultraviolet my such as an excimer laser is used, a material which transmits the far-ultraviolet ray, such as quartz or fluorite, is used as the glass material, and when an F2 laser or X-ray is used, a reflection/refraction system or a refraction system is used as the optical system, and a reflection type mask is used for the mask.

When a linear motor is used for the substrate stage and the mask stage, either of an air floating type using an air bearing or a magnetic floating type using Lorentz force or reactance force may be used. Moreover, the respective stages may be of a type which moves along a guide, or a guideless type without a guide.

As the drive for the respective stages, a planar motor may be used where either a magnetic unit (a permanent magnet) or an armature unit is connected to the stages, and the other of the magnetic unit and the armature unit may be provided on the moving plane side of the stages.

The reaction force generated by the movement of the substrate stage may be removed mechanically to the floor (ground) using a frame member, as described in Japanese Unexamined Patent Application, First Publication No. Hei 8-166475. The present invention is also applicable to exposure apparatus having such a construction.

The reaction force generated by the movement of the mask stage may be removed mechanically to the floor (ground) using a frame member, as described in Japanese Unexamined Patent Application, First Publication No. Hei 8-330224. The present invention is also applicable to exposure apparatus having such a construction.

As described above, the exposure apparatus of the embodiments is produced by assembling various sub-systems including respective constituents mentioned in the claims of this application, so as to maintain a predetermined mechanical precision, electric precision and optical precision. To ensure these various precisions, there are performed adjustments for obtaining optical precision for the various optical systems, adjustments for obtaining mechanical precision for the various mechanical systems and adjustments for obtaining electrical precision for the various electric systems, before and after assembly. The assembly process from various subsystems to the exposure apparatus includes mechanical connection, wing connection of electric circuits and piping connection of pneumatic circuits between various sub-systems. Prior to the assembly process from the various sub-systems to the exposure apparatus, there is, of course, an assembly process for each sub-system. After the assembly process from various subsystems to the exposure apparatus has been completed, comprehensive adjustment is performed, to thereby ensure various precisions for the overall exposure apparatus. In addition, it is desirable that the production of the exposure apparatus be performed in a clean room where the temperature, the degree of cleanness and the like are controlled.

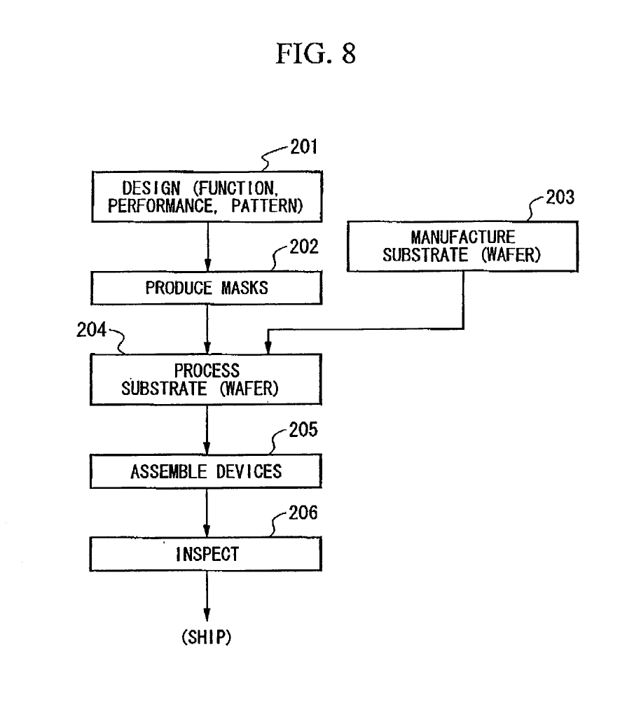

A semiconductor device is produced, as shown in FIG. 8, through steps such as a step 201 for designing the function and performance of the device, a step 202 for producing masks (reticles) based on the designing step, a step 203 for producing wafers from a silicon material, a substrate processing step 204 for exposing a pattern of a mask by means of the exposure apparatus in the above described embodiments, a device assembly step (including a dicing step, a bonding step and a packaging step) 205, and an inspection step 206.

### INDUSTRIAL APPLICABILITY

The measuring method, measuring apparatus, exposure method and exposure apparatus of the present invention have the following effects.

According to the measuring method and the measuring apparatus of the present invention, when an optional substance contained in a predetermined gas is measured by the measuring section, the optional substance remaining in the measuring section can be reduced by supplying a specific gas in which the concentration of the optional substance is reduced, to the measuring section. Then by supplying the predetermined gas to the measuring section in which the optional substance has been reduced, the optional substance can be measured accurately, and highly reliable measurement data can be obtained. At this time, by alternately supplying the predetermined gas and the specific gas, measurement can be performed efficiently within a short period of time, even in a region where the optional substance contained in the predetermined gas is in a small amount.

When the measuring method of the present invention is applied to measurement of concentration of an optional substance in the predetermined gas, accurate concentration measurement can be performed in all concentration regions by alternately supplying the predetermined gas and the specific gas, even when the concentration of the optional substance is in a low concentration region (several ppm), and hence highly reliable measurement data can be obtained. Moreover, when the concentration of the optional substance in the predetermined gas changes, the concentration at the time of measurement can be accurately monitored.

At this time, the specific gas is supplied to the measuring section, and when the measurement of concentration becomes lower than a predetermined value, the predetermined gas is supplied. Thereby, concentration measurement can be efficiently performed corresponding to the desired measurement accuracy. The supply of the specific gas may be carried out corresponding to the target measurement accuracy, and hence excessive supply of the specific gas can be avoided, thereby enabling efficient measurement

According to the exposure method and the exposure apparatus of the present invention, a specific gas in which an absorptive substance is reduced is supplied to a measuring section capable of measuring the absorptive substance, thereby enabling reduction of the absorptive substance remaining in the measuring section. Since the absorptive substance in the space is measured by the measuring section in which the absorptive substance has been reduced, the absorptive substance in the space can be measured accurately and promptly. Therefore, the condition in the optical path space, for example, whether the optical path space is in a normal state capable of performing transfer processing, can be determined accurately and promptly, thereby enabling stable exposure processing with excellent working efficiency.

At this time, by alternately supplying the gas in the space and the specific gas to the measuring section, measurement can be performed efficiently within a short period of time, even in a region where the absorptive substance in the space is in a small amount. Moreover, when the amount of the absorptive substance in the space changes, the absorptive substance at the time of measurement can be accurately monitored.

1. A measuring method for measuring an optional substance contained in a predetermined gas, comprising the steps of:
prior to supplying a predetermined gas to a measuring section capable of measuring said optional substance, supplying a specific gas in which a concentration of said optional substance has been decreased, to said measuring section, and
after supplying said specific gas to said measuring section, supplying said predetermined gas to said measuring section and measures said optional substance.

2. A measuring method according to claim 1, wherein supply of said predetermined gas, and supply of said specific gas are alternately performed.

3. A measuring method according to claim 1, wherein a concentration of said optional substance in said predetermined gas is measured.

4. A measuring method according to claim 3, wherein said specific gas is supplied to said measuring section, and when a measurement value of a concentration of said optional substance becomes less than a predetermined value, said predetermined gas is supplied.

5. A measuring apparatus for measuring an optional substance contained in a predetermined gas, comprising:
a measuring section capable of measuring said optional substance;
a predetermined gas supply unit that is connected to the measuring section and supplies said predetermined gas to said measuring section;
a specific gas supply unit that is connected to the measuring section and supplies a specific gas in which a concentration of said optional substance has been reduced, to said measuring section; and
a switchover device that is provided with the measuring section and switches the gas supply to said measuring section, between from said predetermined gas supply unit and from said specific gas supply unit so as to supply said predetermined gas after supplying said specific gas.

6. A measuring apparatus according to claim 5, further comprising a control unit connected to said switchover device which executes switching of said gas supply a plurality of times.

7. A measuring apparatus according to claim 5, wherein said measuring section measures a concentration of said optional substance in said predetermined gas.

8. A measuring apparatus according to claim 5, wherein said control unit executes supply of said specific gas to said measuring section, and when a measurement value of said concentration becomes less than a predetermined value, operates said switchover device.

9. A measuring apparatus according to claim 5, wherein said predetermined gas and said specific gas are the sane type of gas.

10. An exposure method in which an exposure light is irradiated onto a mask, and an image of a pattern formed on the mask is transferred to a substrate, comprising the steps of:
after supplying to a measuring section capable of measuring an absorptive substance which absorbs said exposure light in a space containing an optical path of said exposure light, a specific gas in which said absorptive substance has been reduced, measuring the absorptive substance in said space by said measuring section, and performing said transfer processing according to said measurement result.

11. An exposure method according to claim 10, wherein supply of the gas in said space, and supply of said specific gas are alternately carries out, and after alternately carrying out said supply, said absorptive substance is measured.

12. An exposure method according to claim 10, wherein a concentration of the absorptive substance in said space is measured and after the concentration of the absorptive substance in said space becomes less than a predetermined value, said transfer processing is performed.

13. An exposure method according to claim 10, wherein said space containing the optical path of said exposure light is divided into a plurality of spaces, and said measuring section is selectively connected to said plurality of spaces.

14. An exposure method according to claim 10, wherein a concentration of the absorptive substance exhausted from said space is monitored and when the concentration of said absorptive substance is less than a predetermined value, said space is connected to said measuring section.

15. An exposure apparatus which irradiates an exposure light onto a mask, and transfers an image of a pattern formed on the mask to a substrate, comprising:
a measuring section that is connected to a space containing an optical path of said exposure light and measures an absorptive substance which absorbs the exposure light;
a gas guide unit that is connected to said measuring section and guides a gas in said space to said measuring section;
a specific gas supply unit that is connected to said measuring section and supplies a specific gas in which said absorptive substance has been reduced to said measuring section;
a switchover device that is provided with the measuring section and switches the gas supply to said measuring section, between from said gas guide unit and from said specific gas supply unit; and
a control unit that is connected to said switchover and controls said switchover device so as to guide gas to said measuring section from said gas guide unit after supplying specific gas from said specific gas supply unit.

16. An exposure apparatus according to claim 15, wherein said control unit alternately performs supply of gas in said space, and supply of said predetermined gas.

17. An exposure apparatus according to claim 15, wherein said space containing the optical path of said exposure light is divided into a plurality of spaces comprising; an illumination system housing for housing an illumination optical system which irradiates the exposure light to said mask, a mask chamber for housing a mask stage which holds said mask, a projection system housing for housing a projection optical system which transfers an image of the pattern formed on said mask to a substrate, and a substrate chamber for housing a substrate stage which holds said substrate, and there is provided a control unit which selectively connects said measuring section to said plurality of spaces.

18. An exposure apparatus according to claim 15, further comprising:
a second measuring apparatus which monitors a concentration of the absorptive substance exhausted from said space, wherein
said control unit connects said space to said measuring section based on a monitor result from said second measuring apparatus.
